(19) United States
(12) Patent Application Publication
(10) Pub. No.: US 2013/0056598 A1
(43) Pub. Date: Mar. 7, 2013

(54) Mounting system

(71) Applicant: Radu Alexandru Ghiorghie, Cuyahoga Falls, OH (US)

(72) Inventor: Radu Alexandru Ghiorghie, Cuyahoga Falls, OH (US)

(73) Assignee: InterDesign, Inc., Solon, OH (US)

(21) Appl. No.: 13/199,652

(22) Filed: Sep. 6, 2011

(51) Int. Cl. F16B 47/00

(52) U.S. Cl. 248/205.3

(57) ABSTRACT

A mounting system for affixing fastening elements to a wall, particularly in rooms fitted with tiles, marble panels, or similar wall paneling, wherein the wall should not be punctured or have its surface penetrated in anyway. The mounting system comprises a support having a cavity or other structure for storing an adhesive and allowing uniform distribution of the adhesive on the support for attachment to a wall. At least one air transmission port on the support allows air penetration for ventilating and curing of the adhesive. An opening between the front face of the support and the rear face of the support allows air penetration from the air transmission port and recess to reach the adhesive on the rear face of the support.

### BACKGROUND OF THE INVENTION

1. Field of the Invention

This invention relates to a mounting system for affixing a support to a wall, particularly in rooms fitted with tiles, marble panels, or similar wall paneling, wherein the wall should not be punctured or have its surface penetrated in anyway.

2. Description of the Prior Art

A large number of mounting systems for affixing supports and materials on walls in the bathroom and kitchen, for example, is known in the art. The simplest systems are those which allow a wall's surface to be penetrated. Such penetration is usually effected by means of fasteners such as screws which form holes or require the drilling of holes in the wall which may result in damage to the wall, especially if the wall comprises tile, marble panels or similar brittle wall structure. For example, tiles may crack, splinter or may be unable to carry a heavy load after the drilling of holes. Moreover, if the support is ever removed, the drill holes must be closed up or the wall structure replaced around the drill holes which is time consuming and difficult. Furthermore, such wall penetration would often spoil the appearance of the wall. Therefore, non-penetrating systems are desirable, but have not heretofore been attainable in an economical fashion. These non-penetration support systems use various types of attaching structure or attaching media to attach the support to the wall. Such securing structure or attaching media can include suction mounts, adhesive tapes, adhesives, etc. However, various types of problems arise when using such conventional methods to attach a support to a wall, on which support a supported item such as a container would be attached for holding heavy objects. For example, adhesive tapes and adhesives in general are not strong enough to attach a support to a wall to support a container to carry the load, and other adhesives such as silicone glue require ample time to cure before the support is firmly attached to the wall. The latter requires that the support be held in place until the adhesive is cured. If a supported item such as a container is prematurely attached to a support on a wall before the adhesive or sealant is completed cured, the adhesive bond may be weakened which may result in premature failure of the bond, causing the support and the container or other supported item to fall off the wall (as used herein, a “support” is an item attached to a wall, a “supported item” is an item supported by the “support” and could be either a container for holding additional material or a hanging item such as a mirror). Moreover, air flow is usually restricted to the areas where the adhesive is curing which results in longer curing times.

In order to decrease the overall cure time of an adhesive or sealant, it is known in the art to use various means to speed up the cure time including the use of a fan, heat, or even a hair dryer. These methods require additional installation time which is not desirable. Another option to decrease curing time is to use a drying catalyst with the adhesive or sealant. However, this requires extra steps of measuring the proper amount of drying catalyst and mixing it with water. Moreover, if the water is not mixed thoroughly with the drying catalyst, uneven curing may take place which results in a weaker bond which may lead to failure causing the support to disengage from the mounting surface or wall.

Many adhesives and sealants have a strong odor and may give off toxic fumes based upon their chemical composition. Such adhesives and sealants usually have warning labels to avoid inhaling and to use in well ventilated areas. Moreover, if a supported item is prematurely mounted to a support on a wall before the adhesive or sealant for the support is completed cured, such harmful fumes may become effectively trapped between the support and wall, and the fumes will slowly dissipate causing such fumes to remain around much longer than desired which would be unpleasant and may be unsafe. It is desired to have some type of air pathway to allow any toxic fumes or odors to quickly dissipate into the air after the support has been mounted (and if the supported item has been mounted to support as well) to a surface such as a wall.

U.S. Pat. No. 7,207,543 to Ortwein discloses a mounting system for attaching a support (referred to therein as a base body) to a wall. Ortwein includes the base body constituting a fixing element and having at least one filling opening for introducing a bonding and fixing agent between the wall and the fixing element. The base body also has openings for penetration and distribution of the bonding and fixing agent and is designed so as to be fluid and gas permeable before the fixing element is attached to the wall. Ortwein teaches that the front of the base body, which faces away from the wall, is covered by means of a closure element, particularly one configured in a cap shape, after the base body has been filled with the bonding and fixing agent—and thereby closed off in terms of appearance and, at the same time, protected, so that water deposits and lime deposits and the formation of mold are prevented, whereby the cap-shaped closure element has an accommodation element for holding objects fixed in place, such as shelves, towel holders, lights, attachment holders or similar fixture articles. After the closure element covers the base body, the base body is no longer fluid and gas permeable since the base body is sealed off. Therefore, if the fixing agent is not fully cured before the closure element covers the base body, problems arise as discussed above including 1) restriction of air flow to the areas where the adhesive is curing which results in longer curing times; 2) harmful fumes may become effectively trapped between the closure element and wall and will slowly dissipate causing such fumes to remain around much longer than desired which may be unsafe; and 3) premature failure of the fixing agent, and ultimately the fixing element, if the fixing agent does not cure properly.

Accordingly, there is a need in the art for a simpler mounting system including a mounting medium for application to a wall and a support fixed to the wall by the mounting medium, which may utilize one or more of the above securing methods in less time while still maintaining the required strength to carry heavy loads. Additionally, there is a need for a mounting system that still allows the adhesive or other mounting medium to cure and harmful fumes to dissipate after the support has been fixed to the wall (and the supported item has been attached to support, albeit prematurely). Such mounting system should also be lightweight, inexpensive to produce and require low skill level for installation and should eliminate or at least substantially reduce the above-mentioned problems, limitations and disadvantages of conventionally constructed mounting systems. It is to this need that the present invention is directed.

### SUMMARY OF THE INVENTION

It is an object of the present invention to provide a support to be fixed to a wall, which support is simple to install and can carry heavy loads.

Another object of the present invention is to provide a support to be fixed to a wall, which support utilizes a strong adhesive or sealant such as a silicone adhesive to secure the mounting system to the wall and carry heavy loads.

A further object is the provision of a support to be fixed to a wall using a secondary adhesive to pre-position the support on a wall while allowing the silicone adhesive to cure.

A still further object of the invention is the provision of a support having a cavity or other structure for storing the silicone adhesive and allowing uniform distribution of the adhesive on the support.

Yet another object is to provide a support with an air transmission port to allow air penetration for ventilating and curing of the adhesive.

It is still another object to provide support with a recess on the front face of the support to allow an ample amount of air penetration from the air transmission port.

A still additional object of the present invention is to provide an opening between front face of the support and the rear face of the support to allow air penetration from the air transmission port and recess to reach the adhesive on the rear face of the support.

Another object is to provide a support with a continuous channel for storing the silicone adhesive and allowing uniform distribution of the adhesive on the support.

It is yet a further object to provide a support with a serpentine channel for holding an adhesive for affixing the support to a wall.

An added object is to provide a support with a sinusoidal channel for holding an adhesive to affix the support to a wall.

It is yet an added object to provide a support with two or more channels for storing the silicone adhesive and allowing uniform distribution of the adhesive on the support.

An additional object of the present invention to provide a support having a primary adhesive and a secondary adhesive to initially and permanently attach a support to a wall.

It is another object to provide a support which can accommodate fasteners either alone or in addition to the main adhesive and secondary adhesive.

These and other objects will occur to those skilled in the art from the description to follow and from the appended claims.

### BRIEF DESCRIPTION OF THE DRAWINGS

The invention may take physical form in certain parts and arrangement of parts, the preferred embodiment of which will be described in detail in the specification and illustrated in the accompanying drawings which form a part hereof, and wherein:

FIG. 1 is a rear perspective view of a support according to one of the embodiments of the invention.

FIG. 2 is a rear view of the support shown in FIG. 1.

FIGS. 3 is front perspective view of the support as shown in FIG. 1.

FIG. 4 is a front view of the support shown in FIG. 1.

FIG. 5 is a rear perspective view of the support as shown in FIG. 1 showing the application of an adhesive in a channel on the rear surface.

FIG. 6 is an exploded perspective view of the support of FIG. 1 being initially attached to a wall with a secondary adhesive.

FIG. 7 is an exploded perspective view of the support of FIG. 1 being attached to a wall with fasteners.

FIG. 8 is a perspective view of a utility item being hung on the support of FIG. 1 after the support has been attached to a wall.

FIG. 9 is a perspective view of how the utility item attaches to the support of FIG. 1.

FIG. 10 is a perspective view of the utility item attached to the support of FIG. 1.

FIG. 11 is a rear perspective view of a support according to one of the embodiments of the invention.

FIG. 12 is a rear view of the support shown in FIG. 11.

FIG. 13 is front perspective view of the support as shown in FIG. 11.

FIG. 14 is a front view of the support shown in FIG. 11.

FIG. 15 is a rear perspective view of the support as shown in FIG. 11 showing the application of an adhesive in a channel on the rear surface.

FIG. 16 is an exploded perspective view of the support of FIG. 11 being initially attached to a wall with a secondary adhesive.

FIG. 17 is an exploded perspective view of the support of FIG. 11 being attached to a wall with fasteners.

FIG. 18 is a perspective view of a utility item being hung on the support of FIG. 11 after the support has been attached to a wall.

FIG. 19 is a perspective view of how the utility item attaches to the support of FIG. 11.

FIG. 20 is a perspective view of the utility item attached to the support of FIG. 11.

### DESCRIPTION OF THE PREFERRED EMBODIMENTS

The preferred embodiments of the present invention relate to a support which may be made of any number of different materials. The support should be strong enough to support a supported item being attached to a wall but also strong enough to support the contents of the supported item. The supported item could be a utility item such as a container for holding an additional load, or a hanging item such as a mirror, picture or the like. The “supported item” is referred to below as a “utility item.” In a preferred embodiment, the support may be made from plastic which is manufactured by known injection molding processes. The support itself is not limited to a specific size but can be designed in any size to accommodate the specific supported item to be attached to a wall.

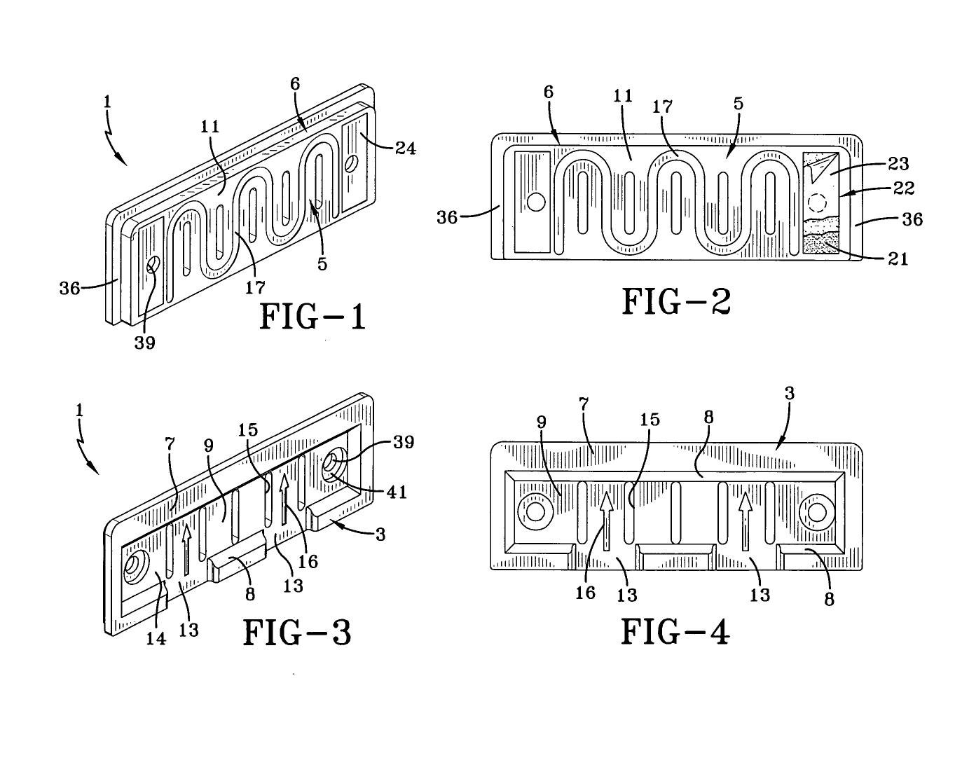

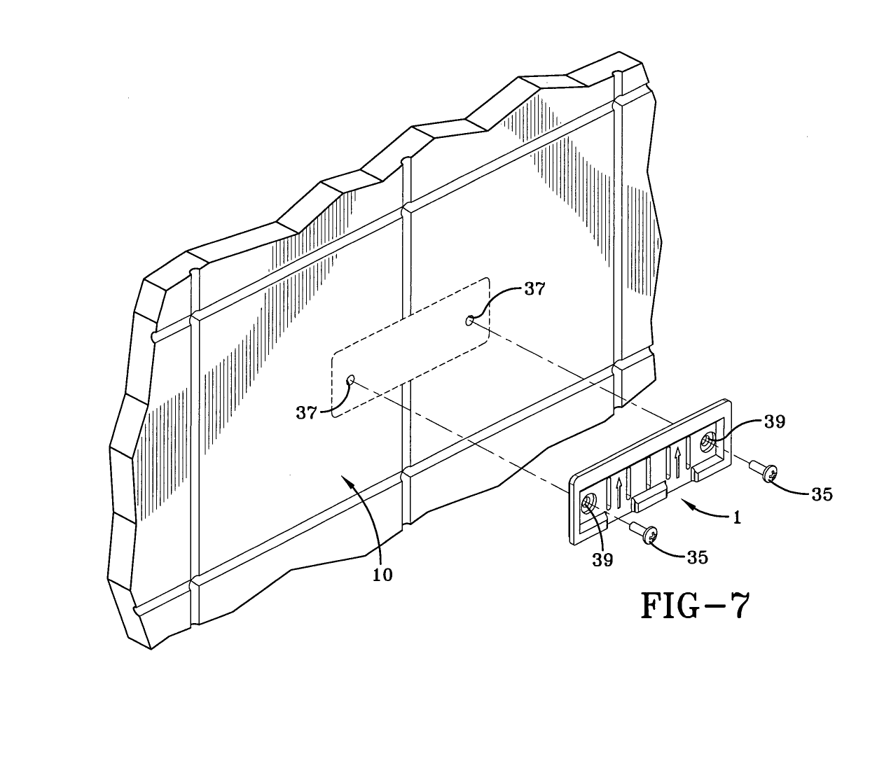

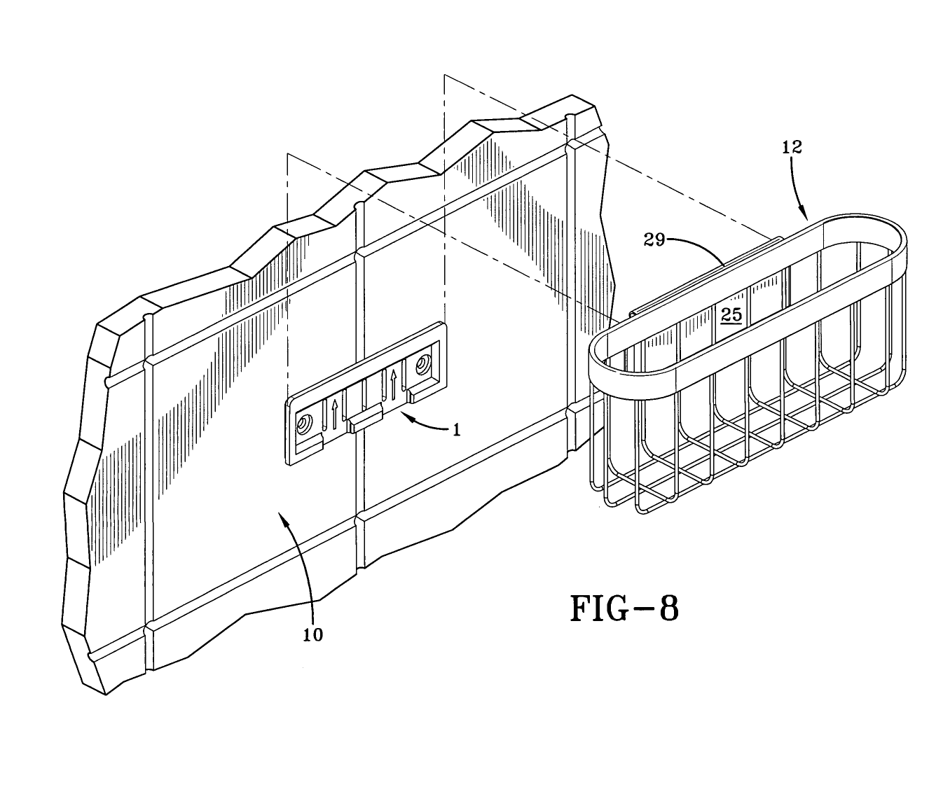

With reference to FIGS. 1-10, a support 1 is shown according to one of the preferred embodiments of the present invention. Support 1 includes a forward side 3 and a rearward side 5. Forward side 3 faces away from a wall 10 (FIGS. 7, 8) when support 1 is attached to wall 10 (“wall” means any vertically oriented surface on which the support discussed herein is to be attached, and could be a building wall, the wall of a cabinet or furniture and the like). Likewise, rearward side 5 faces wall 10 when support 1 is attached to wall 10. Forward side 5 of support 1 includes a support surface 7 and a front surface 9. Support surface 7 of front surface 9 is broken up as described below, and its portions have inclined surfaces 8 defining a rearwardly extending recess 14. Rearward side 5 includes a rear surface 11. Support surface 7 supports a utility item 12 (FIGS. 8-10) mounted on support 1, utility item 12 being shown for example as a container or storage basket made of intersecting wires connected to an upper rim. Support 1 includes structure in the form of breaks in support surface 7 which create two air transmission ports 13 as shown in FIG. 3, although any number of air transmission ports are able to be used, including a single air transmission port. Air transmission ports 13 can be defined by any type of structure where some type of penetration or hole allows the transmission of air from support surface 7 to rear surface 11. In the present embodiment, support 1 has openings 15 between front surface 9 and rear surface 11. Openings 15 allow the passage of air from air transmission ports 13 to front surface 9 and recess 14 and subsequently to rear surface 11. A pair of recessed arrows 16 indicate the direction of air flow, as well as showing the upward direction of support 1 when it is attached to wall 10.

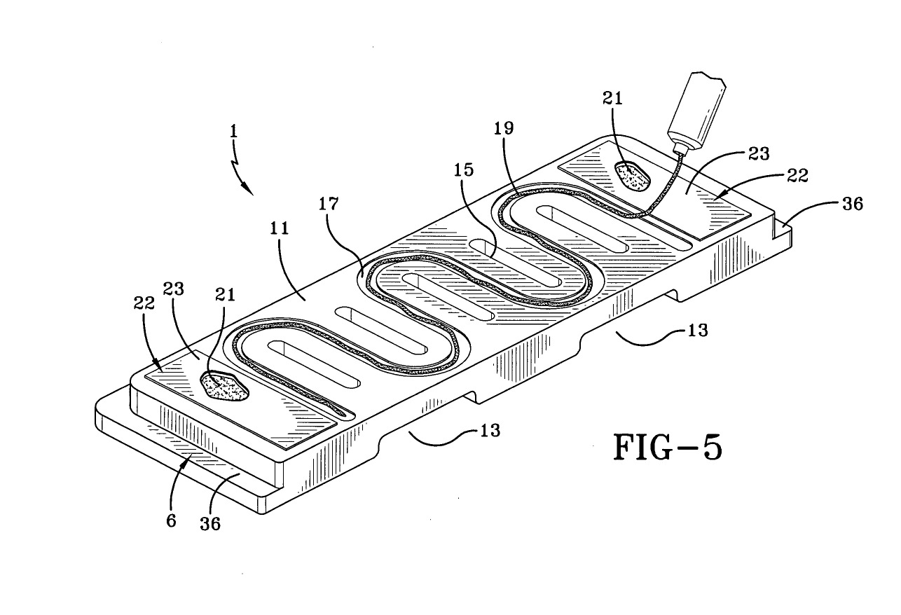

FIGS. 1 and 2 display rearward side 5 of support 1. Rearward side 5 includes a bracket mounting surface 6 for attaching utility item 12 to support 1 on wall 10. In a preferred embodiment, bracket mounting surface 6 may be in the form of a flange extending across the top and opposing side of support 1 and recessed from rear surface 11, although other structure corresponding to support 1 may be used. For example, support 1 and utility item 12 could be provided with a cooperating tongue and groove arrangement. Rear surface 11 includes an adhesive or sealing holding cavity in the form of a channel 17 for holding an adhesive or sealant 19 between support 1 and wall 10 as specifically shown in FIG. 5. Adhesive 19 allows support 1 to attach to wall 10. Any number of channels 17 can be included on rear surface 11. Channel 17 allows adhesive 19 to remain in a set position without spilling over to other parts of rear surface 11, including openings 15. The depth of channel 17 can be minimal to accommodate a very thin layer of adhesive 19. If additional adhesive 19 is desired, the depth of channel 17 can be larger to accommodate more adhesive 19. Channel 17 can take the shape of any number of configurations on rear surface 11. For example, channel 17 can be straight, curved, continuous or discontinuous. In a preferred embodiment as shown in FIGS. 1 and 2, channel 17 takes the shape of a generally sinusoidal or serpentine shape to evenly distribute adhesive 19 across rear surface 11 of support 1. An even distribution of adhesive 19 allows support 1 to be attached to wall 10 with the forces of utility item 12 (and the items that utility item 12 holds) being evenly distributed as well. The even distribution of the forces on support 1 allow heavy items to be placed in utility item 12 without disengaging utility item 12 and support 1 from wall 10.

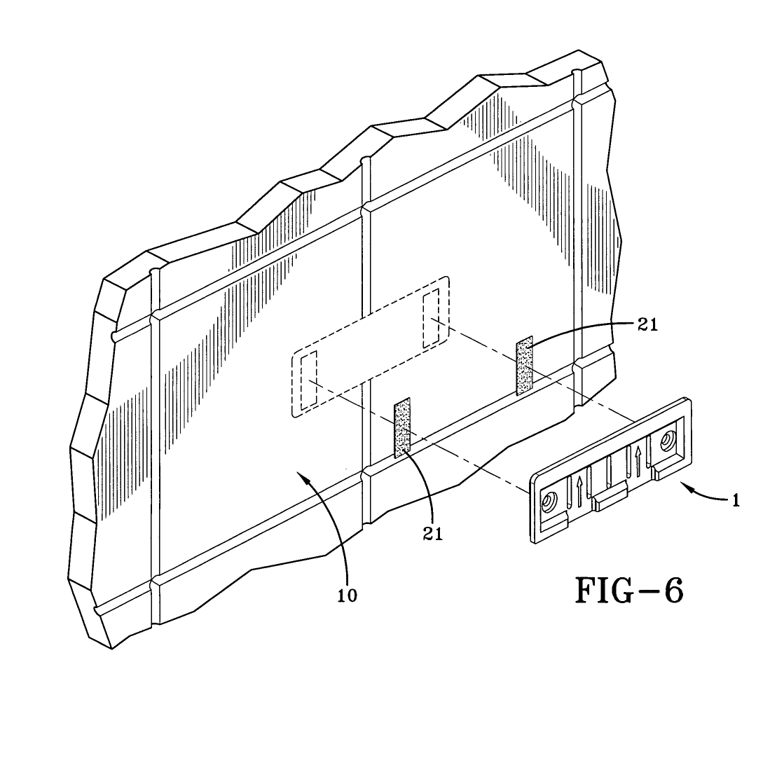

Since adhesive 19 will require time to cure before completely adhering support 1 to wall 10, a secondary adhesive 21 (FIG. 6) may used to attach support 1 to wall and hold support 1 in place while adhesive 19 cures. Secondary adhesive 21 is preferably a quick-curing adhesive which will allow support 19 to quickly attach and remain adhered to wall 10 without being held to wall 10 by other means or a person. For example, secondary adhesive 21 may be coated on a strip, such as a pressure-sensitive adhesive tape 22 with a peel-off backing 23 or a quick-drying glue. Preferably, tape 22 is a pressure-sensitive double-sided tape with one side of the tape attached to rear face 11 of support 1; the other side of tape 22 preferably has a peel-off backing 23, which when removed, renders tape 22 to be readily attached to wall 10 as shown in FIG. 6. Any number of strips of double-sided tape 22 can be located on rear surface 11 of support 1. In the present embodiment, tape 22 or other strips are preferably spaced apart on opposite sides of rear surface 11 as shown in FIG. 5. Additional strips may be included between the strips on opposite sides of rear surface 11 in order to provide more temporary adhesion between support 1 and wall 10 while adhesive 19 is curing. Since the strips of double-sided tape have at least a minimum thickness and may project slightly from rear surface 11, rear surface 11 can include rear surface recesses 24 (FIG. 1) for tape 22 or other strips to be placed in order to reduce or eliminate any projection of strips beyond rear surface 11 as seen in FIGS. 1 and 2. Rear surface recesses 24 thus allow strips to be substantially flush with adhesive 19 thus allowing adhesive 19 to be in contact with wall 10.

Although use of secondary adhesive 21 is preferred in the form of double-sided tape 22, fasteners 35 may also be used to attach support 1 to wall 10 as shown in FIG. 7 to add additional strength to support 1. Fasteners 35 may be used with or without secondary adhesive 21. In order to utilize fasteners 35, holes 37 would need to be drilled in wall 10 by use of a drill known in the art. To accommodate fasteners 35, support 1 has fastener holes 39 and countersinks 41 to cover the head of fastener 35 as shown in FIG. 3. Fastener holes 39 penetrate from front surface 9 of support 1 through rear surface recesses 24 (if they exist), to rear surface 11 and through secondary adhesive 21 as seen in FIG. 1 (secondary adhesive is not shown in FIG. 1, but is shown in FIGS. 2 and 5). If secondary adhesive 21 is not used with fasteners 35, surface recesses 24 are not necessary on rear surface 11.

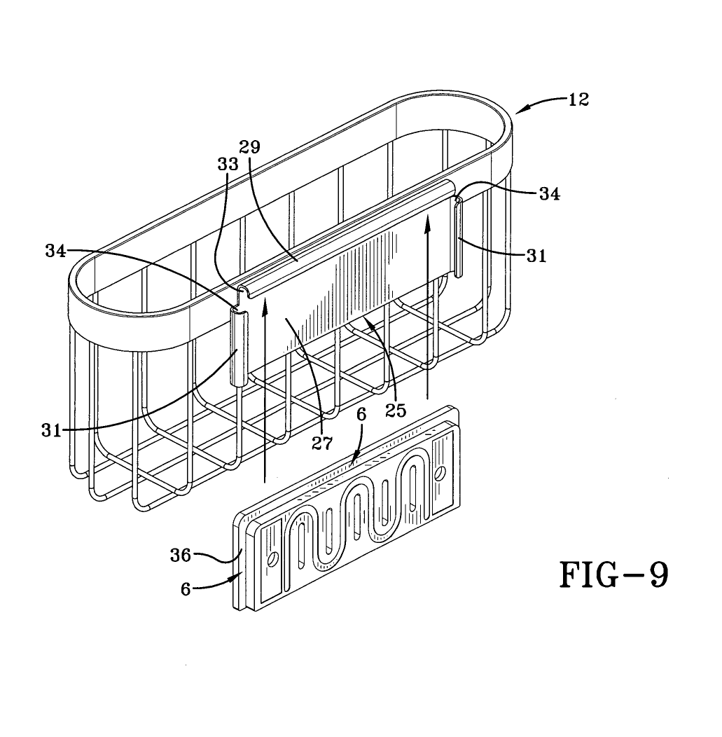

In order to mount a utility item to wall 10 using support 1, some type of corresponding structure on utility item 12 for cooperating with support 1 is needed. In the present embodiment, this structure takes the form of a bracket 25 as shown in FIG. 9. Bracket 25 may be integral with utility item 12 or may be separate from utility item 12. In a preferred embodiment, bracket 25 is integral with utility item 12 and may be attached by welding (particularly if bracket 25 and utility item 12 are made from metal) or similar means. Bracket 25 includes structure which corresponds to the shape of support 1 so support 1 can be located within bracket 25. Bracket 25 includes a rear bracket surface 27, a top holding wall 29 and opposite side walls 31. A front bracket surface opposing rear bracket surface 27 is not visible. In the present embodiment, the front bracket surface is welded to utility item 12, assuming utility item 12 and bracket 25 are made of metal. Top holding wall 29 and side walls 31 are turned-up or curled over away from the front bracket surface to create slots 33 and 34, respectively, for accommodating flange 6 of support 1. After support 1 is mounted to wall 10 and adhesive 19 has cured (or even if adhesive 19 has not fully cured as discussed below), utility item 12 is placed or hung on support 1 by way of bracket 25 as illustrated in FIG. 8. As shown in FIG. 9, slots 33, 34 of utility item 12 slide over opposing side walls 36 of flange 6 until top holding wall 29 engages flange 6. Top holding wall 29 carries the load or weight of utility item 12 (and any contents held by utility item 12) while side walls 31 prevent lateral movement or sliding of utility item 12 when mounted on wall 10. It is possible that top holding wall 29 may be comprised of more than one top holding wall 29 if top holding wall 29 does not span the entire length of support 1.

Air transmission ports 13, recess 14 and openings 15 are important features of the present invention. Air transmission ports 13, recess 14 and openings 15 allow air penetration for ventilating and curing of adhesive 19 after utility item 12 is attached to support 1 on wall 10. It is well known that adhesives and sealants take time to fully cure and this may take 24 hours or more depending on the type of adhesive or sealant as well as the amount of adhesive or sealant used. The curing time is usually specified on the adhesive or sealant (but may not be in some cases). However, many people may not even read the recommended cure time specified by the adhesive or they may disregard it altogether. This may result in people believing that the adhesive or sealant is fully cured when it is not, which would lead to premature installation of utility item 12. As discussed in the foregoing Background of the Invention, installing utility item 12 before adhesive or sealant 19 is fully cured can lead to various types of problems including failure of the adhesive or sealant bond and slow dissipation of harmful fumes.

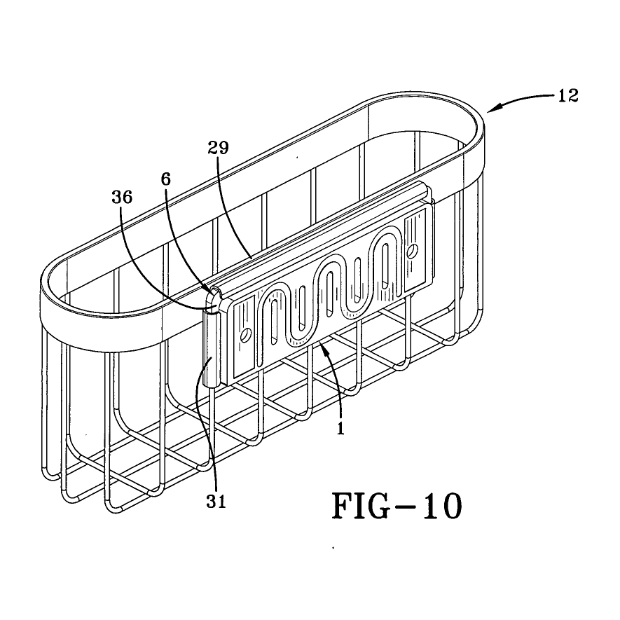

Air transmission ports 13, recess 14 and openings 15 create a pathway for air to reach adhesive 19 on the rear surface 11 of support 1 to allow quicker curing of adhesive 19 and to properly ventilate the harmful fumes of adhesive 19 as described in the following manner. When support 1 is mounted to wall 10 and utility item 12 is then placed on support 1 as shown in FIG. 8, air must be able to reach adhesive 19 between support 1 and wall 10. When the utility item 12 is mounted on support 1 as seen in FIG. 10, front surface 9 of support 1 is planar with rear bracket surface 27 of bracket 25. Similarly, rear surface 11 of support 1 is planar with wall 10. Therefore, in order for air to reach adhesive 19 and for fumes to properly dissipate, air pathways are created in support 1 by air transmission ports 13, recess 14 and openings 15.

Air transmission ports 13 are located at the bottom of support 1 and allow air from the outside to penetrate through air transmission ports 13 and into recess 14. Once the air has entered into recess 14, the air further travels through openings 15 to rear surface 11 of support 1 where adhesive 19 is located. When the air comes into contact with adhesive 19, the curing time of adhesive 19 is accelerated. Moreover, harmful fumes from adhesive 19 now have a pathway to the ambient air by traveling the opposite direction of the air entering air transmission ports 13. That is, harmful fumes travel from rear surface 11 through openings 15 to recess 14 and then through air transmission ports 13 to the ambient air.

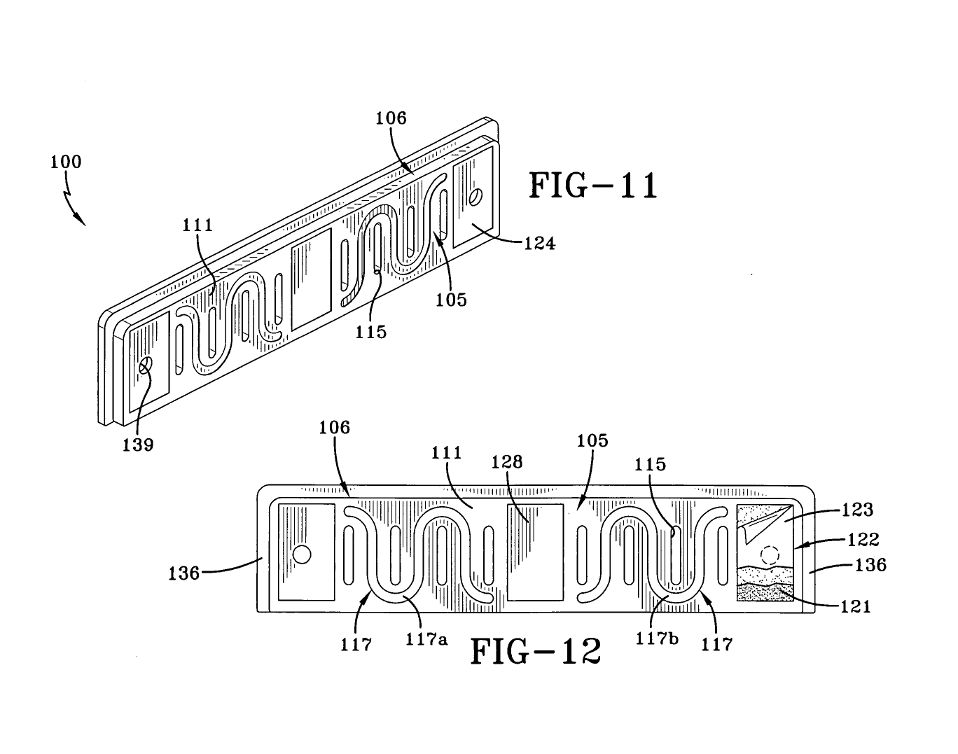

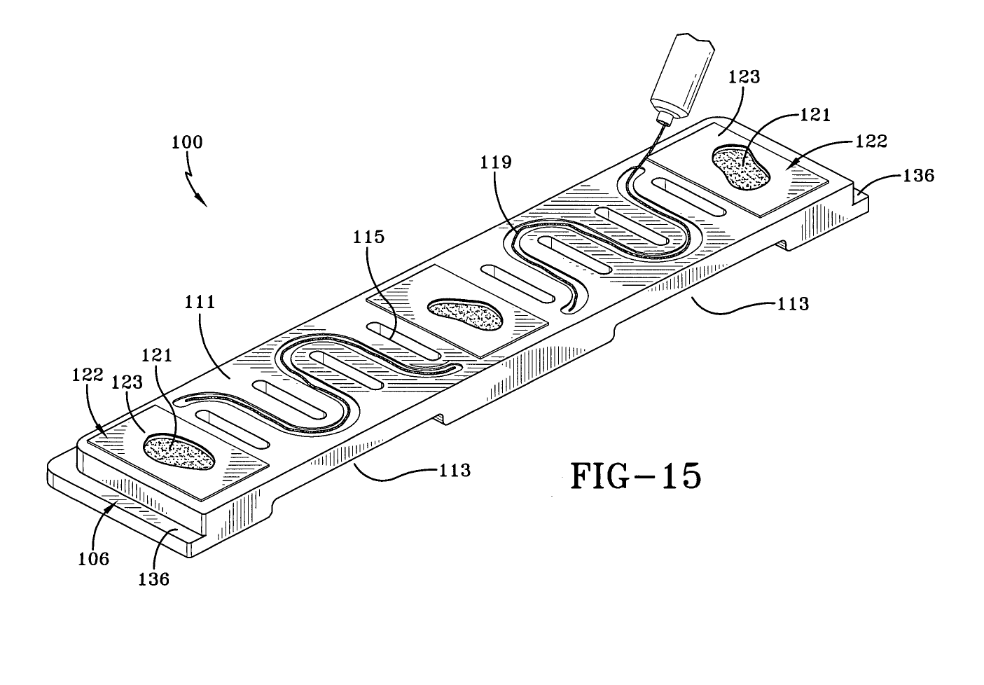

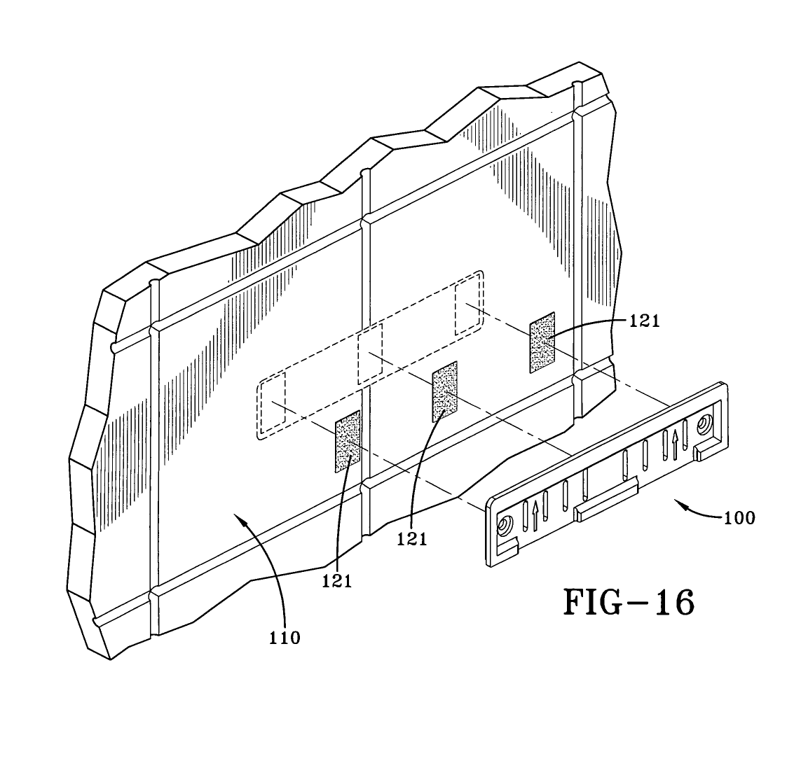

In FIGS. 11-20, another embodiment of the present invention is shown. This second embodiment is similar to the embodiment in FIGS. 1-10 but includes a larger support 100 for supporting a different utility item 112 (and its contents) being attached to a wall.

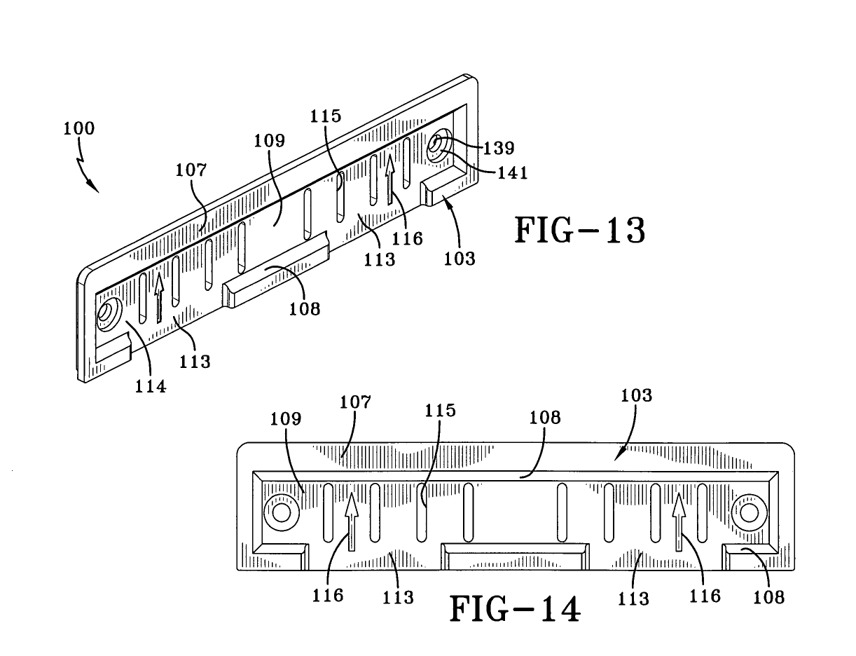

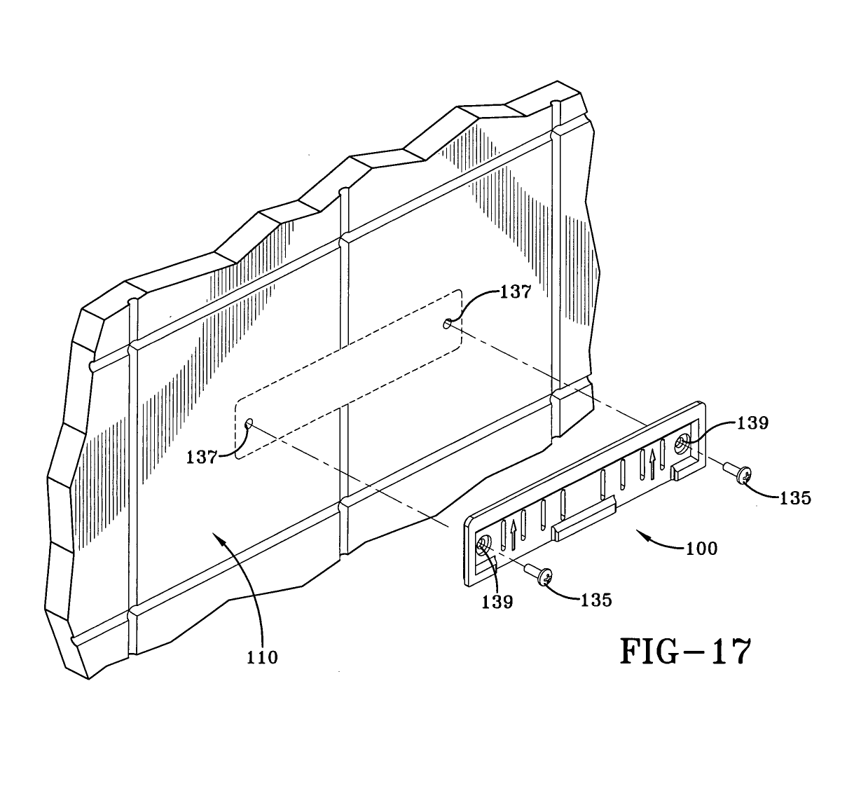

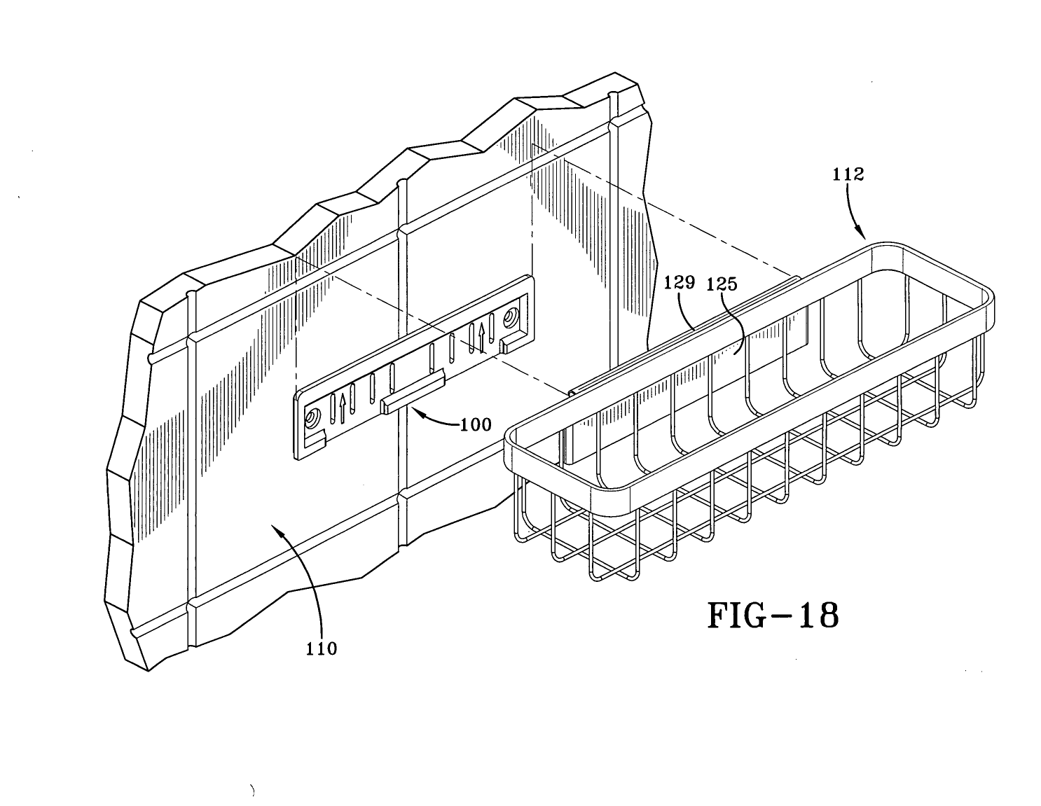

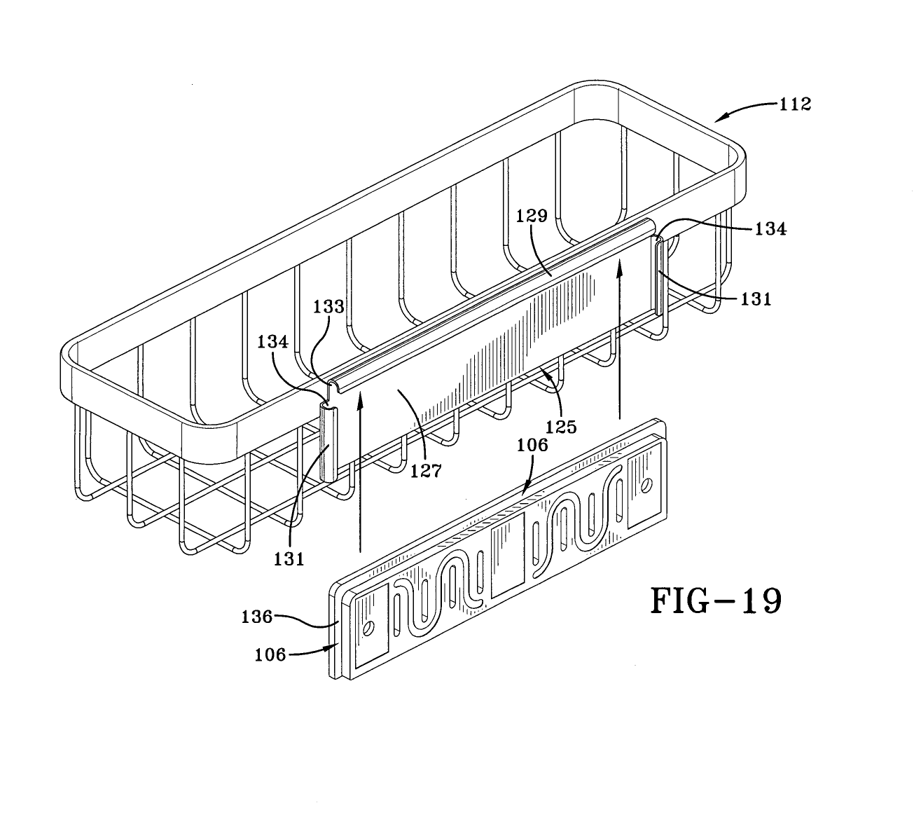

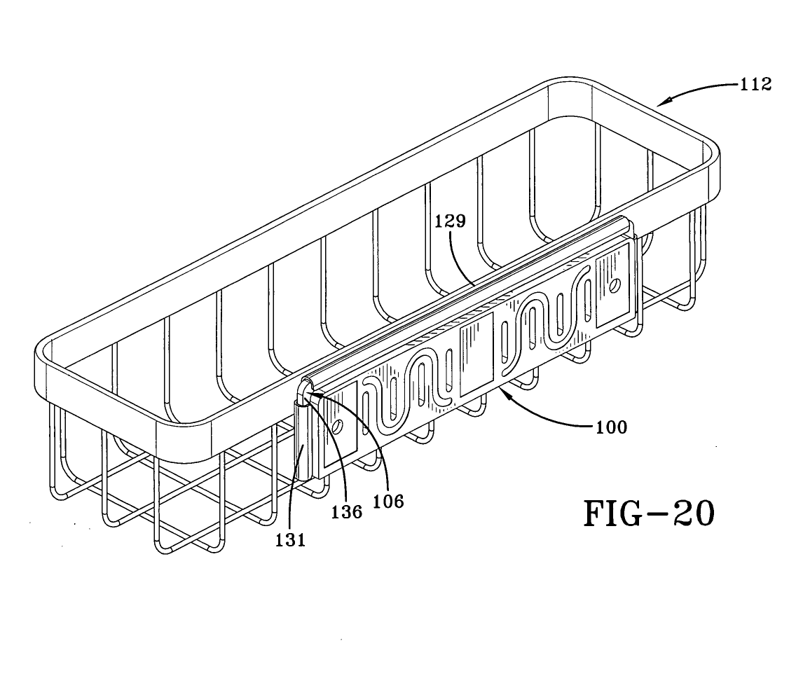

Support 100 includes a forward side 103 and a rearward side 105. Forward side 103 faces away from a wall 110 (FIGS. 16, 17) when support 100 is attached to wall 110. Likewise, rearward side 105 faces wall 110 when support 100 is attached to wall 110. Forward side 105 has a support surface 107 and a front surface 109. Support surface 107 of front surface 109 is broken up as described below, and its portions have inclined surfaces 108 defining a rearwardly extending recess 114. Rearward side 105 includes a rear surface 111. Support surface 107 supports a utility item 112 (FIGS. 19-20) mounted on support 100, utility item 112 being shown for example as a container or storage basket made of intersecting wires connected to an upper rim. Support 100 includes structure in the form of breaks in support surface 107 which create two air transmission ports 113 as shown in FIG. 13. Air transmission ports 113 can be defined by any type of structure where some type of penetration or hole allows the transmission of air from support surface 107 to rear surface 111. Openings 115 between front surface 109 and rear surface 111 of support 100 are seen in FIGS. 11 and 13. Openings 115 allow the passage of air from air transmission ports 113 to front surface 109 and recess 114 and subsequently to rear surface 111. A pair of recessed arrows 116 indicate the direction of air flow, as well as showing the upward direction of support 100 when it is attached to wall 110.

Referring to FIGS. 11 and 12, rearward side 105 of support 100 includes a bracket mounting surface 106 for attaching utility item 112 to support 100 on wall 110. Bracket mounting surface 106 may be in the form of a flange extending across the top and opposing side of support 100 and recessed from rear surface 111. Rear surface 111 includes an adhesive or sealing holding cavity in the form of a channel 117 for holding an adhesive or sealant 119 between support 100 and wall 110 as previously described above with respect to the embodiment of FIGS. 1-10. Channel 117 takes the shape of a generally sinusoidal or serpentine shape to evenly distribute adhesive 119 across rear surface 111 of support 100. However, channel 117 is discontinuous as detailed below, which differs from channel 17 in the first embodiment of FIGS. 1-10.

Support 100 includes a secondary adhesive 121 to attach support 100 to wall and hold support 100 in place while adhesive 119 cures. Secondary adhesive 121 is a pressure-sensitive double-sided adhesive tape strip 122 with a peel-off backing 123 or a quick-drying glue. Since support 100 is used to hold a larger utility item (and its contents), an additional double-sided adhesive tape strip 128 is placed between tape strips 122 as shown in FIGS. 11 and 12 in order to provide additional temporary adhesion to attach support 100 to wall and hold support 100 in place while adhesive 119 cures. In order to provide adequate space on rear surface 111 for additional strip 128, channel 117 is separated into two channel portions 117a and 117b with strip 128 located between channel portions 117a and 117b on rear surface 111. Thus, channel 117 is discontinuous since it comprises two separate channel portions 117a and 117b which are not connected to each other. Any number of channel portions may be on rear surface 111. Rear surface recesses 124 are located on rear surface 111 to allow strips 122, 128 to be substantially flush with adhesive 119 so adhesive 119 can be in contact with wall 110.

Similar to the embodiment of FIGS. 1-10, fasteners 135 may also be used to attach support 100 to wall 110 to add additional strength to support 100. In order to utilize fasteners 135, support 100 has fastener holes 139 and countersinks 141 to cover the head of fastener 135 as shown in FIG. 13. Fastener holes 139 penetrate from front surface 109 of support 100 through rear surface recesses 124 (if they exist), to rear surface 111 and through secondary adhesive 121. If secondary adhesive 121 is not used with fasteners 135, surface recesses 124 are not necessary on rear surface 111.

Similar to the previous embodiment, some type of corresponding structure on utility item 112 for cooperating with support 100 is needed to mount utility item 112 to support 100. In the present embodiment, this structure takes the form of a bracket 125 as shown in FIG. 18. Bracket 125 may be integral with utility item 112 or may be separate from utility item 112. In a preferred embodiment, bracket 125 is integral with utility item 112 and may be attached by welding (particularly if bracket 125 and utility item 112 are made from metal) or similar means. Bracket 125 includes structure which corresponds to the shape of support 100 so support 100 can be located within bracket 125. Bracket 125 includes a rear bracket surface 127, a top holding wall 129 and opposite side walls 131. A front bracket surface opposing rear bracket surface 127 is not visible. In the present embodiment, the front bracket surface is welded to utility item 112, assuming utility item 112 and bracket 125 are made of metal. Top holding wall 129 and side walls 131 are turned-up or curled over away from the front bracket surface to create slots 133 and 134, respectively, for accommodating flange 106 of support 100. After support 100 is mounted to wall 100 and adhesive 119 has cured (or even if adhesive 19 has not fully cured as previously discussed), utility item 112 is placed or hung on support 100 by way of bracket 125 as illustrated in FIG. 17. As shown in FIG. 18, slots 133, 134 of utility item 112 slide over opposing side walls 136 of flange 106 until top holding wall 129 engages flange 106. Top holding wall 129 carries the load or weight of utility item 112 (and any contents held by utility item 112) while side walls 131 prevent lateral movement or sliding of utility item 112 when mounted on wall 110. It is possible that top holding wall 129 may be comprised of more than one top holding wall 129 if top holding wall 129 does not span the entire length of support 100.

The importance of air transmission ports 113, recess 114 and openings 115 when utility item is mounted to support 100 via bracket 125 are the same as previously discussed with respect to the first embodiment, and will not be repeated here.

The invention has been described in detail with particular emphasis on the preferred embodiments thereof, but variations and modifications to those skilled in the art to which the invention pertains.

What is claimed:

1. A support for use with an adhesive for supporting a supported item on a wall, said support having a forward side and a rearward side, and said support comprising:
a forwardly facing support surface for supporting the supported item;
a rearwardly facing rear surface for facing a wall and a forwardly facing front surface for facing away from a wall when said support is attached to the wall, said front surface being recessed from said support surface;
structure defining at least one air transmission port for transmitting air to said front surface when a supported item is mounted on said support;
at least one cavity on said rear surface for holding an adhesive between said support and the wall, said at least one cavity having a base surface forward of said rear surface of said support; and
at least one opening between said rear surface and said front surface and adjacent said at least one cavity, said at least one opening allowing for the air penetration from said at least one air transmission port for ventilating and curing of the adhesive.

2. A support according to claim 1, wherein said at least one cavity is at least one channel.

3. A support according to claim 1, wherein said at least one air transmission port comprises two separate air transmission ports in said support surface.

4. A support according to claim 2, wherein said at least one channel comprises a channel having a generally serpentine shape.

5. A support according to claim 2, wherein said at least one channel is discontinuous.

6. A support according to claim 2, wherein said at least one channel comprises two separate channels.

7. A support according to claim 1 further comprising at least one strip of adhesive tape on said rear surface to further secure said support to a wall.

8. A support according to claim 7, where said at least one strip of adhesive tape is a double-sided tape having a removable layer.

9. A support according to claim 1 and further comprising at least one hole in said support for supporting a fastener to further secure said support to a wall.

10. A support according to claim 1 and further including a mounting surface for holding the supported item.

11. A support according to claim 10, wherein said mounting surface is a flange at least partially surrounding said rear surface.

12. A support according to claim 1 wherein said structure defining at least one air transmission port comprises walls in said support surface defining openings to said front surface even when a supported item is mounted on said support.

13. A support according to claim 1 wherein said at least one opening is at least one slot extending between said front surface and said rear surface.

14. A support according to claim 13 wherein said at least one cavity comprises at least one channel, said at least one channel including a series of connected curves, and said at least one slot is a slot disposed between said curves.

15. A mounting system for supporting a utility item on a wall, said mounting system comprising:
a bracket for a utility item; and
a support having a forward side and a rearward side, said support supporting said bracket mounted on said support, said support comprising:
a support surface for supporting said bracket mounted on said support;
a rearwardly facing rear surface for facing a wall and a forwardly facing front surface for facing away from a wall when said support is attached to the wall, said front surface being recessed from said support surface;
structure defining at least one air transmission port for transmitting air to said front surface when said bracket is mounted on said support;
at least one cavity on said rear surface for holding an adhesive between said support and the wall, said at least one cavity having a base surface forward of said rear surface of said support; and
at least one opening between said rear surface and said front surface and adjacent said at least one cavity, said at least one opening allowing for the air penetration from said at least one air transmission port for ventilating and curing of the adhesive.

16. A mounting system according to claim 15 and further including a mounting surface for holding the supported item.

17. A mounting system according to claim 16 wherein said mounting surface is a flange, and said bracket includes overhanging structure for overhanging said flange to support said bracket.

18. A mounting system according to claim 15, wherein said at least one cavity comprises at least one channel.
